(19) United States
(12) Patent Application Publication
(10) Pub. No.: US 2026/0265609 A1
(43) Pub. Date: Sep. 10, 2026

(54) DYNAMIC PURGE SYSTEM

(71) Applicant: FloWorks International LLC, Houston, TX (US)

(72) Inventor: Jason WALKER, Houston, TX (US)

(73) Assignee: FloWorks International LLC, Houston, TX (US)

(21) Appl. No.: 19/553,419

(22) Filed: Mar. 1, 2026

Related U.S. Application Data
(60) Provisional application No. 63/766,952, filed on Mar. 4, 2025.
(60) Provisional application No. 63/949,807, filed on Dec. 29, 2025.

(51) Int. Cl. C10B 43/08; B08B 9/032

(52) U.S. Cl. CPC C10B 43/08; B08B 9/0325

(57) ABSTRACT

A dynamic purge system is described herein. The dynamic purge system comprises at least one main valve having at least one purge inlet fluidically connected to a cavity within the main valve. Each of the purge inlets is operatively coupled with a controllable valve, which is operatively coupled with a controller, such that each purge inlet can be independently controlled.

This application claims priority to U.S. Ser. No. 63/949,807, filed Dec. 29, 2025 and to 63/766,952, filed Mar. 4, 2025, each incorporated by reference in its entirety for all purposes.

### FIELD OF THE DISCLOSURE

The disclosure generally relates to purge valve configurations for purging deposits from valves, and more particularly to a coker purge valve configuration wherein controllable valves are provided for each purge connection to the coker valve so as to enable dynamic purge control for each purge connection.

### BACKGROUND OF THE DISCLOSURE

Petroleum refining operations where crude oil is processed frequently produce residual oils that have very little value. The value of residual oils can be increased, however, when processed in a delayed coker unit (“DCU”). The DCU heats residual oil in a furnace to a temperature sufficient to cause destructive distillation. During this process a substantial portion of the residual oil is converted, or “cracked” to usable hydrocarbon products, and the remainder is a residual petroleum by-product called “coke,” a material composed mostly of carbon, and which has significant industrial use.

The delayed coker process is a batch process (see FIG. 1) and is one of the most hostile environments in the refinery due to the abrasive and erosive properties of the coke by-product. In the DCU, while one drum is making coke, a second drum is offline, being de-coked. The term “delayed” arises because added water and short residence time in the furnace means some of the coking is delayed and occurs in the coke drum.

The coking batch process requires frequent use of isolation valves during the coke drum switching operation. While one coke drum is stripped, cooled and decoked, these valves allow personnel to safely unhead a cooled drum while the first drum is ‘live’. If the valves do not positively isolate the coker drum, product could leak into the off-line drum creating a safety hazard. The valves isolating the feed heaters are also critical to operation when it becomes necessary to de-coke a heater. If the valves do not isolate, the unit will be shutdown.

Although coker valves are designed to handle the harsh conditions in the refinery, coke buildup inside the valves is inevitable, and any buildup reduces internal tolerances and negatively impacts operations. These valves are thus cycled (replaced) frequently because their failure can lead to complete shutdown, resulting in large process and financial costs. Optimizing valve life-cycle is thus critical to operational efficiency.

Buildup is addressed with purge valves. Purging is the process of removing coke buildup from valves by injecting steam or other available fluid. Purging ports are configured on the coker valves where buildup is likely, for example the cavity and critical components. Steam is injected into the purging ports at high pressure, typically much higher than the operating pressure of the delayed coking process.

Conventionally, all purge ports that are attached to multiple coker valves are connected to the same steam source, and the steam is continuously supplied to prevent buildup. In this setting, large amounts of steam are consumed in the purging process, which contributes to the operational costs. Furthermore, the amount of steam is constant, and not capable of fine control to meet varying operational needs at individual purge ports. For example, the purge inlets continually supply steam even when the valve is closed.

Therefore, there is a need for an improved purging configuration, as well as methods of controlling steam injection as needed, preventing coke buildup, all while reducing steam consumption. The ideal method would allow individualized application of steam as needed at each valve, rather than continuously providing a set amount of steam to every valve. Further, the ideal system would provide maximal steam when any valve is open, reduced steam during switch over, and only a short period of steam on closure, and thereafter halt steam. The ideal system can also be implemented with minimal retrofitting and down time of plants. This invention meets one or more of these needs.

### SUMMARY OF THE DISCLOSURE

The prior art valve purging is designed to prevent coke build up in critical valve cavities by means of pressure differential with a restriction orifice (RO) installed at all purge locations. The process pressure in a DCU is usually about 45 psi, whereas purge pressure is usually about 125 psi. The restricted orifice is installed to restrict steam volume and lower the total steam consumption, while still allowing the steam header to maintain needed pressures for the purging process. However, the RO does not allow for changes to steam usage or to individual main valves or purge inlets.

Conventionally, whether the valve is in travel, open or closed positions, the purge steam is injected at the same rate, which wastes steam when the main valve is closed, and can result in coke build up in cavities when large numbers of purge valves are simultaneously open resulting in pressure drop. Thus, the conventional configuration, as shown in FIG. 2, does not allow strategic purging, leading to high steam usage when not needed, and not enough when needed.

The dynamic purge system disclosed herein provides purge valves that are controllable at each of the purge connections. These are called “controllable purge valves” herein or “CPV.” Each of the CPVs can be independently controlled, based on e.g., temperature, flow, pressure, main valve position, and sensors provided accordingly. This system allows tailored control of each purge connection for each coker valve that may be at different stages of the process.

For example, dynamic purging will allow for increased steam when the main valves are open, reduce the usage in the travel position between open and closed, and reduce or even stop steam usage shortly after the main valve is fully closed. This way, the steam consumption can be micromanaged, drastically reducing total steam consumption, but still allowing steam header to maintain needed pressure. This purge program is exemplary only, however, and depending on the purge function and design and overall system being controlled, the control valves can be programmed to operate to all different positions and timing. In fact, with added sensors to detect pressure, flow, temperature, valve position and the like, complex purging programs can be written and implemented to optimize plant operations. This results in increased main valve reliability by using strategic purging systems to minimize steam consumption while adequately protecting all main valves.

Examples of the dynamic purging system are shown in FIG. 3-4. Here the controllable purge valve or CPV is mounted on the purge connection locations or a nearest suitable location. Sensors can be existing sensors, e.g., on or near the motor operated valve (MOV) which controls main valve open/close position, or sensors can be placed in suitable locations in the piping or even the purge inlet. The difference between FIG. 3 and FIG. 4, is that FIG. 3 shows a retrofitted embodiment, wherein all CPVs on a main valve are controlled by the processor in the actuator on the main valve. In FIG. 4, a central processing unit (CPU) can control the CPVs from multiple main valves.

The invention includes any one or more of the following embodiment(s) in any combination(s) thereof:
A coker valve, said coker valve comprising: a) at least one purge inlet that is fluidly connected to at least one cavity inside said coker valve and fluidly connected to a source of purge fluid; b) wherein said purge inlet is operated by a controllable purge valve (CPV); c) wherein said CPV is operatively coupled to a motor operated valve (MOV) that controls a position of said coker valve; d) wherein said MOV also controls said CPV to thereby control an amount of purge fluid delivered from said source to said cavity.
A coker valve system, said system comprising: a) a plurality of coker valves, each coker valve having at least one controllable purge valve (CPV) that is fluidically connected to at least one cavity inside said coker valve and fluidically connected to a purge fluid source; b) wherein each said CPV is operatively coupled to a centralized control system to controlling an amount of steam delivered from said source to each said CPV based on a position of each coker valve position such that: i) a fully open coker valve provides a fully open CPV; ii) a travelling coker valve provides a restricted CPV; and iii) a closed coker valve provides a closed or restricted CPV.
A delayed coker system, comprising a plurality of coker valves controlling flow through said delayed coker system, each said coker valve comprising: a) at least one purge inlet that is fluidly connected to at least one cavity inside said coker valve and fluidly connected to a source of purge fluid; b) wherein said purge inlet is operated by a controllable purge valve (CPV); wherein each said CPV is operatively coupled to a central controller that controls a position of each said CPV to thereby control an amount of purge fluid delivered from said source to each said cavity based on a position of each said coker valve such that: i) a fully open coker valve provides a fully open CPV; ii) a travelling coker valve provides a restricted CPV; and iii) a closed coker valve provides a closed or restricted CPV.
A main valve, said main valve comprising: a) at least one purge inlet that is fluidly connected to at least one cavity inside said main valve and fluidly connected to a source of purge fluid; b) wherein said purge inlet is operated by a controllable purge valve (CPV); c) wherein said CPV is operatively coupled to a controller that controls said CPV to thereby control an amount of purge fluid delivered from said source to said cavity.

Any coker or main valve herein described, wherein said MOV controls an amount of purge fluid to said purge inlet such that: a) when said coker or main valve is fully open, said CPV is fully open; b) when said coker or main valve is in travel, said CPV is restricted; c) when said coker or main valve is fully closed, said CPV is closed or restricted.

Any coker or main valve herein described, wherein said CPV is pneumatically activated.

Any coker or main valve herein described, wherein said CPV is electrically activated.

Any coker or main valve herein described, wherein said CPV is hydraulically activated.

Any coker or main valve herein described, said coker or main valve selected from a two-way ball valve, a three-way ball valve, a 4-way ball valve, an isolation valve, or a safety valve.

Any coker valve herein described, wherein said coker valve is a coke drum switching valve.

Any coker or main valve herein described, wherein said coker or main valve is an isolation valve.

A delayed coker unit comprising a plurality of any coker valves described herein.
A method of dynamically purging a main valve, said main valve having at least one purge inlet that is fluidically connected to at least one cavity within said main valve, each said purge inlet being operatively coupled to a controllable purge valve (CPV), and each said CPV being operatively coupled to a processor for controlling said CPV and thereby controlling an amount of purge fluid delivered to said purge inlet and cavity, the method comprising the steps of: a) detecting a predetermined parameter selected from temperature, pressure, flow rate, main valve position valve or combinations thereof; and b) adjusting a purge flow rate into said cavity via said processer controlling said CPV based on said predetermined parameter.

Any method herein described, wherein said CPV is pneumatically activated, or electrically activated or hydraulically activated. The purge media used can be any typically used in the industry. For example, steam, atmospheric gas oil (AGO), or vacuum gas oil (VGO).

In addition, the main valves can be any valve that is equipped with a purge inlet. For example, gate valve, ball valves, butterfly valves, sliding gate valves, lift plugs valves, rising stem valves and the like.

As used herein, a “coker valve” is a valve specially built for the extreme conditions of a coker unit, and thus comprises highly durable materials for contact with corrosive and caustic materials and high cycling, extreme temperature changes. Coker valves are typically made from materials like A217 Gr. C12, A217 Gr. C5, INCOLOY® 800 H, and 317 stainless steel, which are chosen for their ability to withstand harsh conditions and thermal cycling in refinery environments. These materials help ensure durability and reliability in the coking process.

Herein, coker valves are exemplary only, and any discussion of a coker valve applies to any main valve in a chemical or other plant.

As used herein, a “controllable purge valve” or “CPV” is a valve that can be remote controlled by a processor and in some cases sensors, such that system usage may be automated to some extent. The controllable purge valves can be any suitable control valve configured to control purge fluid flow by varying the size of the flow passage as directed by a signal from a controller. The opening or closing of automatic control valves is usually done by electrical, hydraulic or pneumatic actuators, herein pneumatic actuators may be preferred. The controller can be programmed into the existing actuator processor mounted atop most main valves in service, or if a new system is being installed, a single central controller can control all purge fluid usage in the plant or in a particular zone of a plant. Main valve may be controlled by the same processor if desired.

Controllable valves are made by many manufacturers including SCHLUMBERGER®, VALMET™, EMERSON®, MCMASTER-CARR™, FESTO USA™ to name a few. Controllable purge valves are also common in the automotive industry.

The CPV can be controlled by a remote signal from either the CPU in the MOV or a separate dedicated CPU using a programmable logic controller (PLC), digital control system (DCS), network control system (NCS), etc. can be used. Suitable protocols include DELTAV™, TRICONEX™, MODBUS™, 2 wire protocol, and the like.

The CPV can also (or in the alternative) be controlled by sensors. As one example, a flow sensor can active a purge when flow is decreasing. Typically however, the sensors are on the main valve or piping related thereto and feed information to the processor on the main valve.

As used herein, the word “travel” refers to a valve that is in the process of travelling from an open to a closed position or vice versa. Such a valve is said to be “in travel.”

A “restricted” CPV is one that is not fully open, but not fully closed either, but somewhere therebetween.

A “closed” CPV is fully closed, but even when the CPV is closed, such as when the main valve is closed, the CPV may run for a brief period of time on closure to ensure that process fluids are swept from the valve. The period of time will vary based on flow rates, tolerances in the valve, as well as the fluids being processed, but in a coker unit will be 0.5-2 minutes or about 1 minute.

The use of the word “a” or “an” when used in conjunction with the term “comprising” in the claims or the specification means one or more than one, unless the context dictates otherwise.

The term “about” means the stated value plus or minus the margin of error of measurement or plus or minus 10% if no method of measurement is indicated.

The use of the term “or” in the claims is used to mean “and/or” unless explicitly indicated to refer to alternatives only or if the alternatives are mutually exclusive.

The terms “comprise”, “have”, “include” and “contain” (and their variants) are open-ended linking verbs and allow the addition of other elements when used in a claim.

The phrase “consisting of” is closed, and excludes all additional elements.

The phrase “consisting essentially of” excludes additional material elements, but allows the inclusions of non-material elements that do not substantially change the nature of the invention.

The following abbreviations are used herein:

| ABBREVIATION | TERM |
|---|---|
| AGO | atmospheric gas oil |
| CPU | central processes sing unit |
| CPV | controllable purge valve |
| DCS | digital control system |
| MOV | motor operated valve |
| NLC | network logic controller |
| PLC | programmable logic controller |
| RO | restriction orifice |
| VGO | vacuum gas oil |

### BRIEF DESCRIPTION OF THE DRAWINGS

FIG. 1. Prior art: Delayed coking system.

FIG. 2. Prior art: Conventional purge configuration.

FIG. 3. An example of a retrofitted dynamic purge system wherein controllable purge valves are directed by logic in the motor operated valve which has a processor to control the main valve.

FIG. 4. An example of a new dynamic purge system wherein the CPVs throughout the plant or a zone thereof are controlled by a centralized controller.

### DETAILED DESCRIPTION

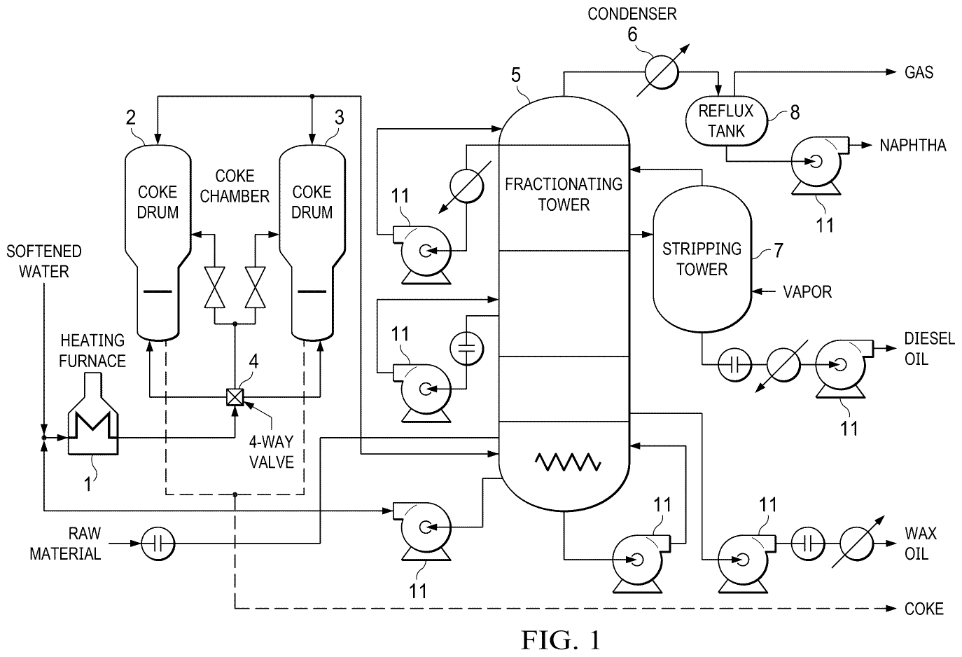

FIG. 1 depicts a simplified schematic of a delayed coker unit with furnace 1, coke drums 2 and 3, and 4-way switch valve 4. Feed enters the furnace from the left, along with water to delay the coking, and from there enters drum 2 or drum 3, depending on the switch valve 4. The process fluid continues the coking process in these drums 2 or 3 on an alternating basis, and is eventually removed and sold. Lighter material travels to the fractionater 5, condenser 6, stripper 7, and refluxer 8 to produce products such as gas, naptha, diesel, and wax, which are separately collected and sold. Several pumps 11 move process fluids around and most of the valves and sensors are omitted herein for simplicity.

While first coke drum 2 is online and being filled, second coke drum 3 is going through a decoking process to purge the manufactured coke contained therein. Thereafter, when first coke drum 2 has reached capacity, the drum inlet is switched via switch valve 4 (often a 4-way ball valve) to second coke drum 3 that has previously been purged of its contents. Then first coke drum 2 is cooled for the decoking process where its contents will be purged, typically with hydraulic jets, and the coke collected for sale. This cyclical process, commonly referred to as batch-continuous, allows the refinery to maintain continuous uninterrupted operation.

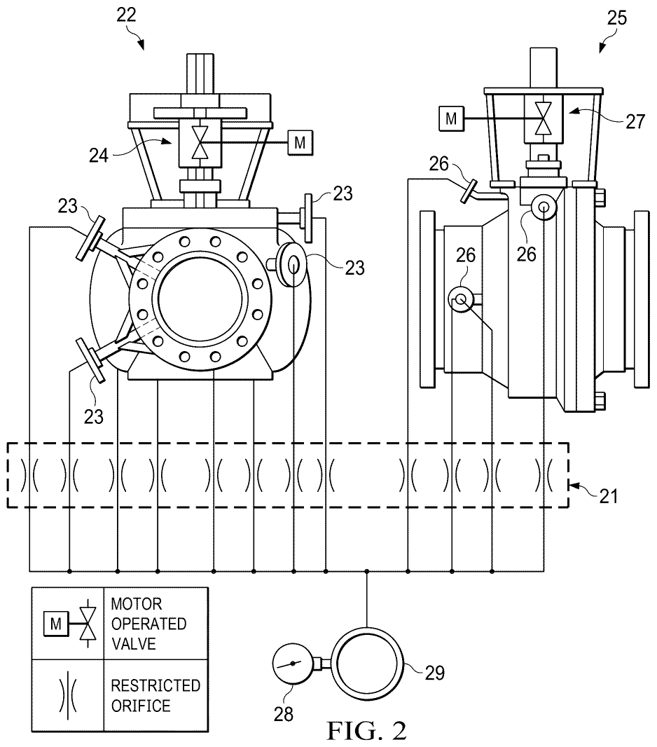

FIG. 2 shows prior art switch and isolation valves and the typical purging system. Here we see switch valve 22 and isolation valve 25, each has purge inlets 23, 26 and the main valves are motor operated valves 24, 27 having internal programming to control the main valve. The purge inlets are not controllable, but rely on a fixed orifice or “restricted orifice” 21. Steam gauge 28 and steam source 29 provide the steam for the purge inlets 23, 26 and provide the only steam control, all inlets getting the same steam pressure. In this system, steam cannot be individually controlled, and much steam is wasted since steam is always running.

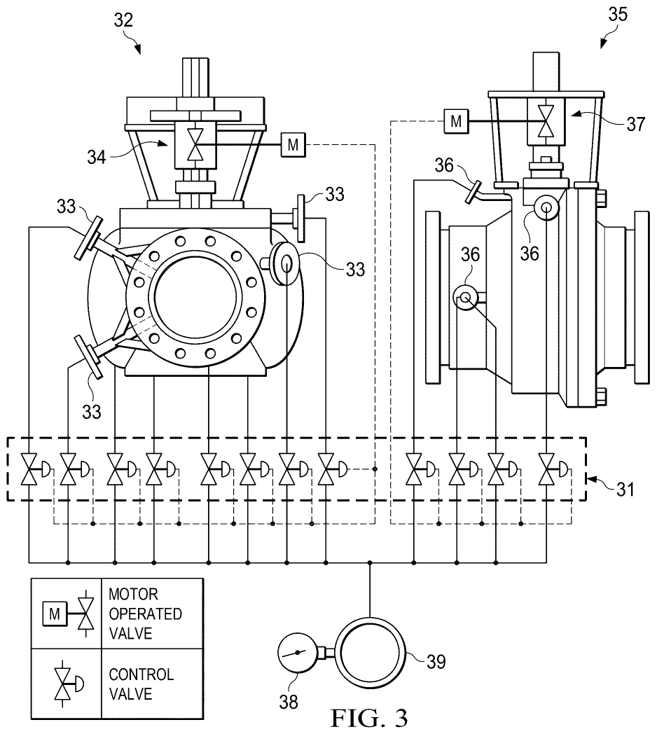

FIG. 3 is similar to FIG. 2, but herein the restricted orifices 21 are replaced with controllable purge valves 31. Each control valve 31 can be controlled by the motor operated valve MOV 34, 37, thus minimal retrofitting of the plant is required, needing only to switch 21 to 31, connect 31 to MOV 34, 37 and to program the processor in the MOV 34, 37. Each valve 32, 35 has purge inlets 33, 36 and steam gauge 38 and steam source 39 provide the steam for the purge inlets 33, 36.

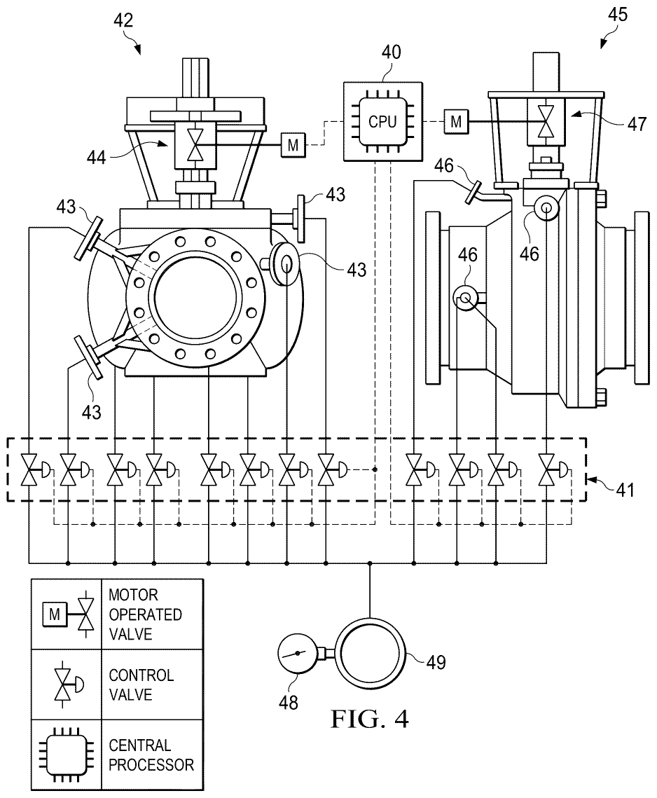

If the main valve is manually operated, then a system such as FIG. 4 can be used, or individual processors can control the CPVs from one or more main valves.

FIG. 4 is the same as FIG. 3 but instead of being controlled by the MOV 44, 47 in each coker (or main) valve 42, 45, the CPVs 41 are controlled by a central processor 4, so all plant valves 41 or those in a zone thereof can be controlled the same CPU 4. Otherwise, the numbers are as follows: valves 42, 45 with purge inlets 43, 46, steam gauge 48, steam source 49. In a new plant, it would even be possible to centrally control each MOV 44, 47 with the CPU 4, as shown here.

The advantage of implementing CPVs into any plant with valving and valve deposition issues is that control of steam usage can be varied based on the main valve position. Furthermore, with added sensors and suitable programming the purge valve can be individually controlled in a sophisticated and optimal manner, depending on plant needs.

Although we have exemplified this invention in the extreme valve environment of the delayer cooker unit, the invention can be used in any coker or chemical unit, water treatment plant, large engine or anywhere where valve deposition is a problematic issue.

The following references are incorporated by reference in their entirety for all purposes.
U.S. Pat. No. 8,282,074 Delayed coker isolation valve systems
U.S. Pat. No. 8,459,608 Seat and valve systems for use in delayed coker system
en.wikipedia.org/wiki/Delayed_coker
en.wikipedia.org/wiki/Control_valve

1. A coker valve, said coker valve comprising:
a) at least one purge inlet that is fluidly connected to at least one cavity inside said coker valve and fluidly connected to a source of purge fluid;
b) wherein said purge inlet is operated by a controllable purge valve (CPV);
c) wherein said CPV is operatively coupled to a processor in a motor operated valve (MOV) that controls a position of said coker valve;
d) wherein said processor in said MOV also controls said CPV to thereby control an amount of purge fluid delivered from said source to said cavity.

2. The coker valve of claim 1, wherein said processor in said MOV controls an amount of purge fluid to said purge inlet such that:
a) when said coker valve is fully open, said CPV is fully open;
b) when said coker valve is in travel, said CPV is restricted;
c) when said coker valve is fully closed, said CPV is closed or restricted.

3. The coker valve of claim 1, wherein said CPV is pneumatically activated.

4. The coker valve of claim 1, wherein said CPV is electrically activated.

5. The coker valve of claim 1, wherein said CPV is hydraulically activated.

6. The coker valve of claim 1, said coker valve is selected from a two-way ball valve, a three-way ball valve, a 4-way ball valve, an isolation valve, or a safety valve.

7. The coker valve of claim 1, said coker valve is a coke drum switching valve.

8. The coker valve of claim 1, said coker valve is an isolation valve.

9. A delayed coking unit comprising a plurality of the coker valves of claim 1.

10. A main valve, said main valve comprising:
a) at least one purge inlet that is fluidly connected to at least one cavity inside said main valve and fluidly connected to a source of purge fluid;
b) wherein said purge inlet is operated by a controllable purge valve (CPV);
c) wherein said CPV is operatively coupled to a controller that controls said CPV to thereby control an amount of purge fluid delivered from said source to said cavity.

11. The main valve of claim 10, wherein said controller operates to control said CPV such that:
i) when said main valve is fully open, said CPV is fully open;
ii) when said main valve is in travel, said CPV is restricted;
iii) when said main valve is fully closed, said CPV is closed or restricted.

12. The main valve of claim 10, wherein said CPV is pneumatically activated.

13. The main valve of claim 10, wherein said CPV is electrically activated.

14. The main valve of claim 10, wherein said CPV is hydraulically activated.

15. A delayed coker system, comprising a plurality of coker valves controlling flow through said delayed coker system, each said coker valve comprising:
a) at least one purge inlet that is fluidly connected to at least one cavity inside said coker valve and fluidly connected to a source of purge fluid;
b) wherein said purge inlet is operated by a controllable purge valve (CPV);
c) wherein each said CPV is operatively coupled to a central controller that controls a position of each said CPV to thereby control an amount of purge fluid delivered from said source to each said cavity based on a position of each said coker valve such that:
i) a fully open coker valve provides a fully open CPV;
ii) a travelling coker valve provides a restricted CPV; and
iii) a closed coker valve provides a closed or a restricted CPV.

16. A coker valve system, said system comprising:
a) a plurality of coker valves, each coker valve having at least one controllable purge valve (CPV) that is fluidically connected to at least one cavity inside said coker valve and fluidically connected to a purge fluid source;
b) wherein each said CPV is operatively coupled to a centralized control system to control an amount of steam delivered from said source to each said CPV based on a position of each coker valve position such that:
i) a fully open coker valve provides a fully open CPV;
ii) a travelling coker valve provides a restricted CPV; and
iii) a closed coker valve provides a closed or restricted CPV.

17. A method of dynamically purging a main valve, said main valve having at least one purge inlet that is fluidically connected to at least one cavity within said main valve, each said purge inlet being operatively coupled to a controllable purge valve (CPV), and each said CPV being operatively coupled to a processor for controlling said CPV and thereby controlling an amount of purge fluid delivered to said purge inlet and cavity, the method comprising the steps of:
a) detecting a predetermined parameter, selected from temperature, pressure, flow rate, main valve position valve or combinations thereof; and
b) adjusting a purge flow rate into said cavity via said processer controlling said CPV based on said predetermined parameter.

18. The method of claim 17, wherein said CPV is pneumatically activated.

19. The method of claim 17, wherein said CPV is electrically activated.

20. The method of claim 17, wherein said CPV is hydraulically activated.

21. The method of claim 17, wherein said predetermined parameter is a position of each main valve position such that:
i) a fully open main valve provides a fully open CPV;
ii) a travelling main valve provides a restricted CPV; and
iii) a closed main valve provides a closed or restricted CPV.
